(19) United States
(12) Patent Application Publication
(10) Pub. No.: US 2026/0258524 A1
(43) Pub. Date: Sep. 3, 2026

(54) METHOD OF RECYCLING WASTE IONOMER MEMBRANE

(71) Applicant: Johnson Matthey Public Limited Company, London (GB)

(72) Inventors: Shireen Kaur BASRA, Royston (GB); Harriet BURDETT, Royston (GB); Jonathan MCCREE-GREY, Royston (GB)

(21) Appl. No.: 19/491,233

(22) PCT Filed: Jun. 20, 2024
(86) PCT No.: PCT/GB2024/051578

§ 371 Date: Dec. 8, 2025

(30) Foreign Application Priority Data
Sep. 12, 2023 (GB) 2313846.4

(51) Int. Cl. C22B 7/00; C22B 3/00; C22B 11/00; C22B 59/00

(52) U.S. Cl. CPC C22B 7/009; C22B 7/007; C22B 11/048; C22B 23/0423; C22B 59/00

(57) ABSTRACT

A method of recycling a waste ionomer membrane comprising platinum, palladium and/or ruthenium disposed within an interior region of the waste ionomer membrane, the method comprising: (a) treating the waste ionomer membrane with a solution comprising an acid and an oxidant, wherein platinum, palladium and/or ruthenium is leached from the interior region of the waste ionomer membrane into the solution; and (b) separating the solution comprising leached platinum, palladium and/or ruthenium from the waste ionomer membrane which remains in solid form during the leaching process.

### FIELD

This specification relates to recycling methods for waste ionomer membranes such as those used in fuel cells and hydrogen producing water electrolysers.

### BACKGROUND

Fuel cell and hydrogen producing water electrolyser production is set for rapid growth as investment is placed into the global hydrogen economy. Catalyst coated membranes (CCMs) are a major functional component of both fuel cells and electrolysers. Such CCMs generally comprise a conductive polymer membrane coated on either side by a catalyst containing layer. The CCMs are configured to drive oxidation and reduction reactions and support proton and electron transport, these processes being required for the fuel cell and electrolyser technologies to function.

While variations in CCM component materials and configurations exist according to functional performance requirements in end use applications, they generally contain several components of value including one or more platinum group metal (PGM) catalysts and one or more proton conducting polymers.

Typically, the membrane is formed of one or more ionomers such as perfluorosulfonic-acid (PFSA) ionomers. Ionomer may also be provided in one or both of the catalyst layers. The ionomer in the catalyst layers may be the same or different to the ionomer in the main membrane component and/or in other catalyst layer(s).

A CCM may comprise two different catalysts, one for driving an oxidation reaction on one side of the CCM and one for driving a reduction reaction on the other side of the CCM. A CCM may also comprise a recombination catalyst disposed within the interior of the ionomer membrane which is provided to catalyse the recombination of hydrogen and oxygen to form water, reducing the quantity of hydrogen crossing the membrane and mixing with oxygen to form a potentially explosive mixture. A CCM may also include a metal oxide (e.g., CeO₂) as a peroxide scavenger within the interior of the ionomer membrane.

CCM catalysts can be based on platinum group metals such as platinum, ruthenium, iridium, palladium, or mixtures thereof. The platinum group metals may be provided in elemental (metallic) form, in compound form (e.g., an oxide, such as an iridium oxide catalyst), or as a PGM-base metal alloy (e.g., PtCo or PtNi). Furthermore, the PGM catalyst materials may be supported on a substrate material (e.g., carbon, such as a platinum-on-carbon catalyst comprising particles of carbon on which platinum is disposed or PtCo-on-carbon or PtNi-on-carbon).

Catalyst coated membranes (CCMs) can also be provided in combination with additional functional layers to form multi-layer membrane electrode assemblies (MEAs). Such MEAs may have 3, 5, or 7 layers for example.

With the increase in CCM manufacture for fuel cells and electrolysers, there is an associated increase in CCM waste materials, including a significant volume of scrap material created during CCM manufacture (e.g., due to failure at quality control) and also an increase in end-of-life (EoL) CCMs. Since CCMs contain several components which are rare and/or valuable, including platinum group metals (notably Pt, Pd, Ir and Ru) and ionomer (both in the membrane and catalyst layers), there is a growing demand for methods of recycling such components from waste CCM materials.

One current method to recover PGMs from production scrap and end-of-life CCM material involves incineration. The incineration process yields a PGM rich (typically Pt and Ir) ash which is processed via conventional PGM refining routes. However, the incineration process releases harmful and toxic gases such as CO₂ and HF from the polymers that are part of the membrane. Both these gases have negative impacts as they pollute the atmosphere, increase the greenhouse effect, and/or have harmful effects in the human body. As such, there is a need for a cleaner process which reduces or eliminates the emission of these gases.

In addition to the above, the incineration method destroys the ionomer component which also has significant value. As such, it would also be desirable to provide a process which is capable of recovering both PGM and ionomer components as well as providing a process which is cleaner, safer, and more environmentally friendly. Processes for recovering perfluorosulphonic acid ionomer are known. See, for example, WO2016/156815 and U.S. Pat. No. 7,255,798. Furthermore, processes for recovering individual PGM catalyst components are known. See, for example, U.S. Pat. No. 7,709,135. However, to enable fuel cells and electrolysers to become more sustainable technologies, there is a need for commercially viable and environmentally friendly routes to recover, separate, and recycle both the PGMs and the ionomer components from waste CCM materials including production scrap and end-of-life material.

It is an aim of the present specification to address this problem.

### SUMMARY OF INVENTION

The present specification is particularly concerned with the recovery of metals which are disposed within an interior region of an ionomer membrane rather than in catalyst coatings on the exterior surfaces of an ionomer membrane. As noted in the background section, ionomer membranes can be provided with a recombination catalyst disposed within the interior of the ionomer membrane which is provided to catalyse the recombination of hydrogen and oxygen to form water, reducing the quantity of hydrogen crossing the membrane and mixing with oxygen to form a potentially explosive mixture. Furthermore, ionomer membranes may be provided with base-metal containing components within the interior of the ionomer membrane including, for example, peroxide scavengers (e.g., a metal oxide such as CeO₂). Further still, it has been found that metal components from catalyst coatings on the ionomer membrane can migrate into the interior of the ionomer membrane in use. Accordingly, even after the catalyst coatings have been removed from the ionomer membrane for recycling, a portion of the valuable metal components from the catalyst coatings can remain within the interior of the ionomer membrane.

It is desirable to recover such metal components from the interior of a waste ionomer membrane for at least two reasons. First, the metal components are valuable and scarce, and thus there is an economic and environmental driver for recovering and re-using these materials. Secondly, by recovering these metals from the interior of a waste ionomer membrane, the ionomer can subsequently be recovered and re-used without being contaminated with these metals.

The present specification thus provides a method of recycling a waste ionomer membrane comprising platinum, palladium and/or ruthenium disposed within an interior region of the waste ionomer membrane, the method comprising: (a) treating the waste ionomer membrane with a solution comprising an acid and an oxidant, wherein platinum, palladium and/or ruthenium is leached from the interior region of the waste ionomer membrane into the solution; and (b) separating the solution comprising leached platinum, palladium and/or ruthenium from the waste ionomer membrane which remains in solid form during the leaching process.

It has been found that such a leaching process using an acid and an oxidant can successfully remove metal components from the interior of a waste ionomer membrane enabling recycling of these metal materials while also cleaning the waste ionomer membrane of interior metal components such that the ionomer material can then be dispersed and recovered for re-use without significant metal contamination.

Further details of the methodology are provided in the detailed description below.

### BRIEF DESCRIPTION OF THE DRAWINGS

For a better understanding of the present invention and to show how the same may be carried into effect, certain embodiments of the present invention will now be described by way of example only with reference to the accompanying drawing, in which:

FIG. 1 shows a waste ionomer membrane recycling process according to the present specification.

### DETAILED DESCRIPTION

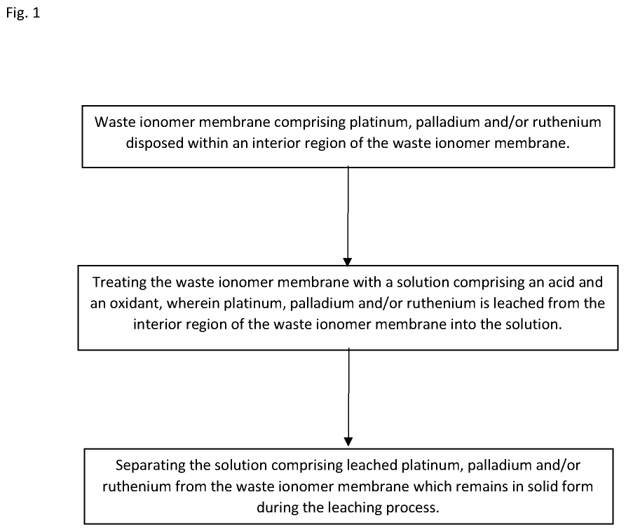

As described in the summary section and illustrated in FIG. 1, according to one aspect of the present specification there is provided a method of recycling a waste ionomer membrane comprising platinum, palladium and/or ruthenium (and optionally one or more non-PGM metals) disposed within an interior region of the waste ionomer membrane, the method comprising: (a) treating the waste ionomer membrane with a solution comprising an acid and an oxidant, wherein platinum, palladium and/or ruthenium (and optionally one or more of the non-PGM metals) is leached from the interior region of the waste ionomer membrane into the solution; and (b) separating the solution comprising leached platinum, palladium and/or ruthenium from the waste ionomer membrane which remains in solid form during the leaching process.

The waste ionomer membrane may comprise one or more base metals within the interior region of the waste ionomer membrane in addition to platinum, palladium and/or ruthenium. The one or more base metals are also leached into the solution with the platinum, palladium and/or ruthenium and, after separation from the waste ionomer membrane, the solution is subsequently processed to separate the one or more base metals from the platinum, palladium and/or ruthenium. The one or more base metals may include one or more of cerium, optionally in the form of CeO₂, nickel, and cobalt. As previously discussed, CeO₂ is useful in the ionomer membrane as a peroxide scavenger to increase the lifetime of the membrane whereas nickel and/or cobalt may migrate into the ionomer membrane from catalyst coatings on the membrane in use. At least a portion of the platinum, palladium, ruthenium and/or base metal disposed within the interior region of the waste ionomer membrane may also have migrated from a catalyst coating into the interior region of the waste ionomer membrane in use. For example, the catalyst coating may have comprised a platinum-nickel catalyst and at least a portion of one or both of the platinum and nickel may have migrated into the interior region of the waste ionomer membrane in use.

At least a portion of the platinum, palladium and/or ruthenium may be in the form of a recombination catalyst disposed within the interior region of the waste ionomer membrane. The recombination catalyst can be in the form of a layer disposed within the interior region of the waste ionomer membrane or dispersed across a thickness of the interior region of the waste ionomer membrane. The recombination catalyst may be a platinum black recombination catalyst.

The waste ionomer membrane may be one which does not have a catalyst coating on either or both major surfaces of the membrane. This may be because the waste ionomer membrane is production scrap which was never coated with a catalyst coating or because the catalyst coating has been removed prior to leaching of the waste ionomer membrane to remove platinum, palladium and/or ruthenium from the interior region thereof.

The acid used in the leach of platinum, palladium and/or ruthenium is advantageous hydrochloric acid. The solution used for the leach of platinum, palladium and/or ruthenium can be heated, optionally to a temperature of: at least 50° C., 60° C., or 70° C.; no more than 160° C., 100° C., or 90° C.; or within a range defined by any combination of the aforementioned lower and upper limits, wherein if the solution is heated above 100° C. then this is done in a pressurized vessel. The oxidant in the leaching solution may comprise hydrogen peroxide, a chlorate salt, or chlorine gas. In certain examples, the acid used in the leach of platinum, palladium and/or ruthenium is hydrochloric acid and the oxidant is chlorine gas generated from the hydrochloric acid electrolytically in-situ. The oxidant can be added to the acid solution or generated in-situ to a total concentration of oxidant of: at least 0.001, 0.005, or 0.01 mol/I; no more than 1, 0.5, or 0.10 mol/I; or within a range defined by any combination of the aforementioned lower and upper limits (e.g., in a range 0.01 to 0.10 mol/I). The solution for leaching platinum, palladium and/or ruthenium may have an acid concentration of: no less than 4 M, 5 M, or 5.5 M; no more than 12 M, 10 M, 7 M, 6.5 M, or 6 M; or within a range defined by any combination of the aforementioned lower and upper limits.

After separating the solution containing the leached platinum, palladium and/or ruthenium from remaining solid components of the waste catalyst coated membrane material, the solution can be concentrated by boiling the solution down. Alternatively, or additionally, after separating the solution containing the leached platinum, palladium and/or ruthenium from remaining solid waste ionomer membrane, the solution can be re-used to leach platinum, palladium and/or ruthenium from further waste ionomer membrane. The solution can then be further processed to separate and purify individual metal components using known PGM and base metal refining techniques.

After subjecting the waste ionomer membrane to one or more of the leaching steps to remove the platinum, palladium and/or ruthenium, the waste ionomer membrane can be heated in a solvent to disperse and recycle the ionomer.

### Examples

The overarching aim is to recover the valuable components of fuel cells and water electrolysers, particularly the recovery of PGMs. One aspect of this process is an understanding of how PGMs and other metals within the interior of the ionomer membrane can be accessed and recovered. These include metals that leach into the ionomer membrane of a CCM during operation and metals which are intentionally placed within the interior of an ionomer membrane of a CCM, such as recombination catalysts and/or peroxide scavengers. In certain processes is it desired to extract the metal components prior to dispersion and processing of the ionomer membrane components. The aim of these experiments is to determine if an oxidative leach of ionomer membranes can remove metals present within the interior of the membranes such that the ionomer membranes can be subsequently processed to recover the ionomer material.

### Ionomer Membranes Leached Using HCl and Peroxide as an Oxidant

In this example, peroxide was used as the oxidising agent in excess with HCl as the acid dissolution and chloride source. Two different types of ionomer membrane containing metal components were treated: (i) ionomer membrane containing platinum black (PtB) recombination catalyst; and (ii) ionomer membrane from a catalyst coated membrane comprising a platinum-nickel (PtNi) catalyst coating where the nickel had leached into the ionomer membrane.

### Leaching Pt-Black Containing Membranes

The membrane was cut into 1×1 cm² pieces. A 500 ml flange vessel was set up with an overhead PTFE stirrer and stirrer guide on top of a hot plate. A temperature probe, connected to the hot plate, and condenser with cooling water were also fitted.

400 mL of 12 M HCl was added to the vessel along with 0.5 mL of H₂O₂. 10 to 15 g of Pt black recombination catalyst containing membrane was then added to the vessel and the reaction mixture stirred at 250 rpm. The system was heated to a temperature of 70° C. and then maintained at this temperature for 50 mins.

The solution was cooled to room temperature and filtered using a buchner funnel and 0.45 μm cellulose nitrate filter paper. The remaining leached membrane pieces were washed with water and the liquor and washings were collected separately.

The residual membrane pieces were left to air dry overnight on a watch glass before being sent for analysis.

Leaching Membrane from PtNi CCMs

A 500 mL round bottom flask was fitted with a stirrer bead, temperature probe connected to the hot plate, stopper and condenser with cooling water.

200 mL of 12 M HCl was added to the vessel along with 0.5 mL of H₂O₂ and stirred at 1000 rpm. One piece of a PtNi CCM, cut into 0.5×0.5 cm² pieces, was added to the vessel and minimal volumes of distilled water were used to wash the CCMs into the vessel. The system was heated and once it reached a temperature of 70° C. it was heated for a further 50 mins.

The solution was cooled to room temperature and filtered using a buchner funnel and 0.45 μm cellulose nitrate filter paper. The remaining leached CCMs were washed with water. The liquor and washings were collected separately.

The residual CCM pieces were left to air dry overnight on a watch glass before being sent for analysis.

### Results

Analysis indicated that the HCl leach using peroxide as an oxidant can recover all the Pt, Ni, and Ce from within the ionomer membrane samples. An example of the XRF data is shown in the table below indicating recovery of all the Pt and Ce within the ionomer membrane. ICP analysis also indicated 100% recovery of the Ni in the membrane from PtNi CCMs in which nickel had migrated into the interior of the ionomer membrane.

| | Pt mg | | Ce mg | |
|---|---|---|---|---|
| Sample | cm⁻² | ± | cm⁻² | ± |
| Original membrane | 3.921 | 0.366 | 11.08 | 0.972 |
| After leaching (Sample 1) | 0.014 | 0.077 | 0.01 | 0.079 |
| After leaching (Sample 2) | 0.027 | 0.071 | 0.021 | 0.164 |
| After leaching (Sample 3) | −0.018 | 0.062 | −0.031 | 0.106 |
| After leaching (Sample 4) | −0.044 | 0.059 | −0.085 | 0.124 |
| After leaching (Sample 5) | 0.02 | 0.17 | −0.021 | 0.254 |
| Average element content | −0.0002 | | −0.0212 | |
| after leaching | | | | |
| % decrease in metal | 100.0051 | 0.0878 | 100.1913 | 0.1454 |
| content | | | | |

These results are important because during operation of a fuel cell/water electrolyser, metals will migrate into the ionomer membrane. Furthermore, metal containing components are being engineered into ionomer membranes to improve functionality and lifetime of the membranes. This work has shown we can access those metals via an oxidative acid leaching process and that it is possible to extract the metal trapped in the ionomer membrane first, prior to dispersing and recovering the ionomer.

### Ionomer Membranes Leached Using HCl and NaClO₃ as an Oxidant

In this example, NaClO₃ was used as the oxidising agent in excess with HCl as the acid dissolution and chloride source. Two different types of ionomer membrane containing metal components were treated: (i) ionomer membrane containing platinum black (PtB) recombination catalyst; and (ii) ionomer membrane from a catalyst coated membrane comprising a platinum-nickel (PtNi) catalyst coating where the nickel had leached into the ionomer membrane.

### Leaching Pt-Black Containing Membrane

The membrane was cut into 1×1 cm² pieces. A 500 ml flange vessel was set up with an overhead PTFE stirrer and stirrer guide on top of the hot plate. A temperature probe, connected to the hot plate, and condenser with cooling water were also fitted.

400 mL of 6 M HCl was added to the vessel along with 0.5 mL of NaClO₃ at a concentration of 450 g/L. 10 to 15 g of Pt black recombination catalyst containing membrane was then added to the vessel and the reaction mixture stirred at 250 rpm. The system was then heated to 70° C. and once reached the temperature of the system was maintained for a further 50 mins.

The solution was cooled to room temperature and filtered using a buchner funnel and 0.45 μm cellulose nitrate filter paper. The remaining leached membrane pieces were washed with water. The liquor and washings were collected separately.

The residual membrane pieces were left to air dry overnight on a watch glass before being sent for analysis.

Leaching Membrane from PtNi CCMs

A 500 mL round bottom flask was fitted with a stirrer bead, temperature probe connected to the hot plate, stopper, and condenser with cooling water.

200 mL of 6 M HCl was added to the vessel along with 0.5 mL of NaClO₃ at a concentration of 450 g/L and stirring at 1000 rpm. One piece of a PtNi CCM, cut into 0.5×0.5 cm² pieces, was added to the vessel and minimal volumes of distilled water were used to wash the CCM pieces into the vessel. The system was heated to 70° C. and once the system reached this temperature it was allowed to heat for a further 50 mins.

The solution was cooled to room temperature and filtered using a buchner funnel and 0.45 μm cellulose nitrate filter paper. The remaining leached CCMs were washed with water. The liquor and washings were collected separately.

The residual CCM pieces were washed with distilled water and left to air dry overnight on a watch glass.

### Results

Analysis indicated that the HCl leach using NaClO₃ as an oxidant can recover substantially all the Pt, Ni, and Ce from within the ionomer membrane samples. An example of the XRF data is shown in the table below indicating recovery of substantially all the Pt and Ce within the ionomer membrane. ICP analysis also indicated recovery of the majority of the Ni in the membrane from PtNi CCMs in which nickel had migrated into the interior of the ionomer membrane.

| | Pt mg | | Ce mg | |
|---|---|---|---|---|
| Sample | cm⁻² | ± | cm⁻² | ± |
| Original membrane | 3.921 | 0.366 | 11.08 | 0.972 |
| After leaching (Sample 1) | −0.065 | 0.1 | −0.056 | 0.157 |
| After leaching (Sample 2) | 0.011 | 0.081 | 0.041 | 0.187 |
| After leaching (Sample 3) | 0.199 | 0.017 | 0.0302 | 0.038 |
| Average element content | 0.0483 | | 0.0051 | |
| after leaching | | | | |
| % decrease in metal | 98.767 | 0.066 | 99.954 | 0.127 |
| content | | | | |

It is noted that metal recovery yields were slightly higher when using H₂O₂ as the oxidising agent when compared to NaClO₃. However, the recoveries observed here are still very good.

### SUMMARY

The present specification provides a leaching process to recover PGMs from within the membrane layer of a CCM product as used in fuel cell and hydrogen producing electrolyser applications. Previous experiments had focussed on recovering metals from the coatings of a catalyst coated membrane. The present specification is focussed on recovery of Pt and other metals from within the membrane rather than just the outside coatings. This has been trialed on membrane containing Pt black recombination catalysts and PtNi CCMs which have been found to display migration of metal into the membrane layer. Metal recovery yields approaching 100% have been obtained. This methodology can be applied to ionomer membrane material which contains recombination catalysts and to end of life ionomer membrane material which has experienced migration of metals into the membrane layer during use.

The examples described herein used an oxidative leach in HCl with the oxidant being either sodium chlorate or hydrogen peroxide, with both being successful. However, on scale up it is possible to alternatively use chlorine as an oxidant. As a result of the leaching process, PGMs, base metals and ceria were all recovered, and these may then be separated and purified using known PGM and base metal refining processes.

While this invention has been particularly shown and described with reference to certain examples, it will be understood to those skilled in the art that various changes in form and detail may be made without departing from the scope of the invention as defined by the appended claims.

1. A method of recycling a waste ionomer membrane comprising platinum, palladium and/or ruthenium disposed within an interior region of the waste ionomer membrane, the method comprising:
(a) treating the waste ionomer membrane with a solution comprising an acid and an oxidant, wherein platinum, palladium and/or ruthenium is leached from the interior region of the waste ionomer membrane into the solution; and
(b) separating the solution comprising leached platinum, palladium and/or ruthenium from the waste ionomer membrane which remains in solid form during the leaching process,
wherein at least a portion of the platinum, palladium and/or ruthenium is in the form of a recombination catalyst disposed within the interior region of the waste ionomer membrane.

2. The method according to claim 1,
wherein the waste ionomer membrane comprises one or more base metals within the interior region of the waste ionomer membrane in addition to platinum, palladium and/or ruthenium,
wherein the one or more base metals are leached into the solution with the platinum, palladium and/or ruthenium, and
after separation from the waste ionomer membrane, the solution is subsequently processed to separate the one or more base metals from the platinum, palladium and/or ruthenium.

3. The method according to claim 2,
wherein the one or more base metals include one or more of cerium, optionally in the form of CeO₂, nickel, and cobalt.

4. (canceled)

5. The method according to claim 1,
wherein the recombination catalyst is in the form of a layer disposed within the interior region of the waste ionomer membrane or dispersed across a thickness of the interior region of the waste ionomer membrane.

6. The method according to claim 1,
wherein the recombination catalyst is a platinum black recombination catalyst.

7-8. (canceled)

9. The method according to claim 1,
wherein waste ionomer membrane subjected to the leaching process does not comprise catalyst coating on a surface of the waste ionomer membrane either because the waste ionomer membrane is production scrap which was never coated with a catalyst coating or because the catalyst coating has been removed prior to leaching of the waste ionomer membrane to remove platinum, palladium and/or ruthenium from the interior region thereof.

10. The method according to claim 1,
wherein the acid used in the leach of platinum, palladium and/or ruthenium is hydrochloric acid.

11. (canceled)

12. The method according to claim 1,
wherein the solution used for the leach of platinum, palladium and/or ruthenium is heated to a temperature of: at least 50° C., 60° C., or 70° C.; no more than 160° C., 100° C., or 90° C.; or within a range defined by any combination of the aforementioned lower and upper limits, wherein if the solution is heated above 100° C. then this is done in a pressurized vessel.

13. The method according to claim 1,
wherein the oxidant comprises hydrogen peroxide, a chlorate salt, or chlorine gas.

14. The method according to claim 1,
wherein the acid used in the leach of platinum, palladium and/or ruthenium is hydrochloric acid and the oxidant is chlorine gas generated from the hydrochloric acid electrolytically in-situ.

15. The method according to claim 1,
wherein the oxidant is added to the acid solution or generated to a total concentration of oxidant of: at least 0.001, 0.005, or 0.01 mol/l; no more than 1, 0.5, or 0.10 mol/l; or within a range defined by any combination of the aforementioned lower and upper limits.

16. The method according to claim 1,
wherein the solution for leaching platinum, palladium and/or ruthenium has an acid concentration of: no less than 4 M, 5 M, or 5.5 M; no more than 12 M, 10 M, 7 M, 6.5 M, or 6 M;
or within a range defined by any combination of the aforementioned lower and upper limits.

17. The method according to claim 1,
wherein after separating the solution containing the leached platinum, palladium and/or ruthenium from remaining solid components of the waste catalyst coated membrane material, the solution is concentrated by boiling the solution down.

18. The method according to claim 1,
wherein after separating the solution containing the leached platinum, palladium and/or ruthenium from remaining solid waste ionomer membrane, the solution is re-used to leach platinum, palladium and/or ruthenium from further waste ionomer membrane.

19. The method according to claim 1,
wherein after subjecting the waste ionomer membrane to one or more of the leaching steps to remove the platinum, palladium and/or ruthenium, the waste ionomer membrane is heated in a solvent to disperse and recycle the ionomer.
